(19) United States
(12) Patent Application Publication
(10) Pub. No.: US 2026/0322567 A1
(43) Pub. Date: Oct. 15, 2026

(54) CAPABILITY UTILIZATION AND COMMUNICATION FOR TIME DIVISION DUPLEX

(71) Applicant: ZTE CORPORATION, Shenzhen, Guangdong (CN)

(72) Inventors: Jing SHI, Shenzhen (CN); Xianghui HAN, Shenzhen (CN); Shuaihua KOU, Shenzhen (CN); Xingguang WEI, Shenzhen (CN)

(21) Appl. No.: 19/485,831

(22) PCT Filed: May 19, 2023
(86) PCT No.: PCT/CN2023/095372

§ 371 Date: Nov. 19, 2025

(51) Int. Cl. H04L 5/00; H04L 5/14

(52) U.S. Cl. CPC H04L 5/0094; H04L 5/1469

(57) ABSTRACT

Wireless communications may include improved user equipment (UE) capability utilization and communication. There may be capability sharing between two cells, among multiple cells, between a downlink (DL) carrier and an uplink (UL) carrier, or between/among sub-bands. A capability may have an enhanced value or function that is available after a configuration of one type of carrier aggregation (CA) or a configuration of one cell when the UE already reported. This can support the capability sharing or the capability with the enhanced value or function.

### CROSS REFERENCE

This application is a National Stage Filing of the PCT International Application No. PCT/CN2023/095372 filed on 19 May 2023, the entirety of which is herein incorporated by reference.

### TECHNICAL FIELD

This document is directed generally to wireless communications. More specifically, in a mobile device communications system, user equipment (UE) capability may be utilized and communicated.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for improving user equipment (UE) capability utilization and communication. There may be capability sharing between two cells/carriers/bands, among multiple cells/carriers/bands, between a downlink (DL) carrier and an uplink (UL) carrier, or between/among sub-bands. A capability may have an enhanced value or function that is available after a configuration of one type of carrier aggregation (CA) or a configuration of one cell or one carrier when the UE already reported. This can support the capability sharing or the capability with the enhanced value or function.

In one embodiment, a wireless communication method includes receiving a configuration for a type of carrier aggregation (CA) for multiple carriers, or a configuration for one carrier among the multiple carriers; and utilizing a capability among the multiple carriers or for the one carrier based on the configuration. The type of CA for multiple carriers comprises a complementary Time Division Duplex (TDD). The utilizing the capability among the multiple carriers comprises sharing the capability between two cells or among cells, between a downlink (DL) carrier and an uplink (UL) carrier in one cell, or between two sub-bands or among multiple sub-bands. The complementary TDD is determined by at least one of frame structure and frame boundary offset. The complementary TDD is determined with one of following conditions: a) there is no overlapped slot with a same direction between two cells; b) there is no overlapped symbol with a same direction between two cells; c) there is no overlapped UL slot among cells; d) when there is no overlapped UL symbol among cells; e) there is no overlapped DL slot among cells; f) when there is no overlapped DL symbol among cells; or g) there is at least one overlapped slot or symbol with a different direction among cells. The complementary TDD is determined by an RRC parameter to configure. The method includes utilizing the capability among the multiple carriers by a pattern. The pattern comprises a slot pattern, a carrier pattern, or a joint pattern. For the slot pattern, the utilizing the capability among the multiple carriers or for the one carrier for the slot corresponds with one value in the slot pattern. For the cell pattern, the utilizing the capability among the multiple carriers is based on an indication of the cell pattern. For the joint pattern, the utilizing the capability among the multiple carriers or for the one carrier for the slot corresponds with one value for a carrier combination in the slot pattern. The method includes deriving the pattern by an RRC parameter, or by at least one of frame structure and frame boundary offset. The method includes indicating a number of the carriers for application of the capability. The method includes receiving one carrier combination for application of the capability based on reported multiple carrier combinations. The method includes applying the capability based on an enhanced value among the multiple carriers or for the one carrier. The method includes reporting, by a user equipment (UE), support of the enhanced value of the capability; or reporting, by the UE, support of the capability that can be shared among cells. The capability is available after the configuration, and after the UE had performed the reporting of the support of the enhanced value of the capability or reporting of the support of the capability can be shared among cells. The configuration comprises a parameter based on the enhanced value of the capability. The utilizing the capability among the multiple carriers or for the one carrier is based on the configuration that is further activated/deactivated by a Medium Access Control (MAC) Control Element (CE). The utilizing the capability among the multiple carriers or for the one carrier is based on the configuration that is further activated/deactivated by the MAC CE with a time offset.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example base station.

FIG. 2 shows an example random access (RA) messaging environment.

FIG. 3 shows a block diagram of an example configuration of a transceiver and antenna.

FIG. 4 shows a block diagram illustrating relationships between carriers, bands, and cells.

FIG. 5 illustrates a symbol/slot structure.

FIG. 6 illustrates complementary Time Division Duplex (TDD) Carrier Aggregation (CA).

FIG. 7 illustrates uplink (UL) complementary Time Division Duplex (TDD) Carrier Aggregation (CA) without UL overlap and with three slots offset.

FIG. 8 illustrates uplink (UL) complementary Time Division Duplex (TDD) Carrier Aggregation (CA) without UL overlap and with two slots offset.

FIG. 9 illustrates Time Division Duplex (TDD) cells where partial slots are complementary.

FIG. 10 illustrates an embodiment of CA with three Time Division Duplex (TDD) cells.

FIG. 11 illustrates CA with three Time Division Duplex (TDD) cells in which one cell is configured with slot offset.

FIG. 12 illustrates CA with four cells in which one cell is configured with slot offset.

FIG. 13 illustrates another embodiment of CA with three Time Division Duplex (TDD) cells.

FIG. 14 illustrates CA with three Time Division Duplex (TDD) cells in which two cells are configured with slot offset.

FIG. 15 illustrates a single Time Division Duplex (TDD) cell or carrier with an unbalanced downlink (DL) and uplink (UL) ratio.

FIG. 16 illustrates a single Time Division Duplex (TDD) cell or carrier with a downlink (DL) sub-band and an uplink (UL) sub-band.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

Wireless or mobile communication technology improvements result in increased demands. Based on the current development trend, systems are developing support on features of enhanced mobile broadband (eMBB), ultra-reliable low-latency communication (URLLC), and massive machine-type communication (mMTC). Full duplex may be a requirement for 5G and subsequent communication systems. In wireless communication, a network device, such as a user equipment (UE), may perform uplink (UL) transmitter (Tx) switching between bands. For multi-carrier operation, a network device that transmits with two transmitters (also called a 2Tx user device), may transmit in two UL bands. Which two bands that are used may be changed by radio resource control (RRC) reconfiguration.

The 4th Generation mobile communication technology (4G) Long-Term Evolution (LTE) or LTE-Advance (LTE-A) and the 5th Generation mobile communication technology (5G) have increased demands. Based on the current development trend, 4G and 5G systems are developing support on features of enhanced mobile broadband (eMBB), ultra-reliable low-latency communication (URLLC), and massive machine-type communication (mMTC). Carrier Aggregation (CA) can be both used in 4G and 5G and future communication systems. Multiple carriers or cells from one or more bands can be configured for capacity improvement with user equipment (UE) capability sharing. UE capabilities are shared within carriers/bands/cells. Uplink (UL) transmission (Tx) switching is an example of a UE capability that is shared between two bands from one transmitter. Allowing the UE capability to be shared improves communications if one carrier or one band is not working at a time or is not working within a period/duration. In another example, if some hardware or software can be shared among bands or carriers, higher UE capability could be achieved for some UE with less cost restriction. UE capability sharing is further described in the embodiments below.

In some wireless communication embodiments, an uplink (UL) symbol or slot may be configured/scheduled to transmit data or control information from a user equipment to a base station; and a downlink (DL) symbol or slot may be configured/scheduled to transmit data or control information from the base station to the UE. In one example, for a time division duplex (TDD) carrier, a DL symbol (or slot) and a UL symbol (or slot) may be time-divisionally configured. Operating bands may be defined for utilization by the network operator. The definition for one band may include the frequency region and the duplex mode. The duplex mode may include Frequency Division Duplex (FDD), Time Division Duplex (TDD), Supplementary Downlink (SDL), and/or Supplementary Uplink (SUL). In some embodiments, there may be variable duplex FDD, and the FDD band can be generated by a combination SUL band with SDL band. For full duplex, the non-overlapped sub-band full duplex may be considered and at least one UL sub-band can be supported or configured within a TDD carrier. The combinations are described in the embodiments below to improve flexibility for spectrum utilization. This may achieve the benefit of partial or all kinds of duplex mode, such as low latency, high peak rate, better coverage and high reliability, etc.

Except the UL Tx, other capabilities defined per band or per carrier may not be shared among the carriers or bands. The capability may be wasted if one carrier or one band is not working at a time or within a period/duration. For complementary TDD CA, when the two carriers are both working at a time, each carrier may only used as one transmission direction and capability of the other transmission direction may be wasted. As described in the embodiments below, the capability may be shared and better utilized.

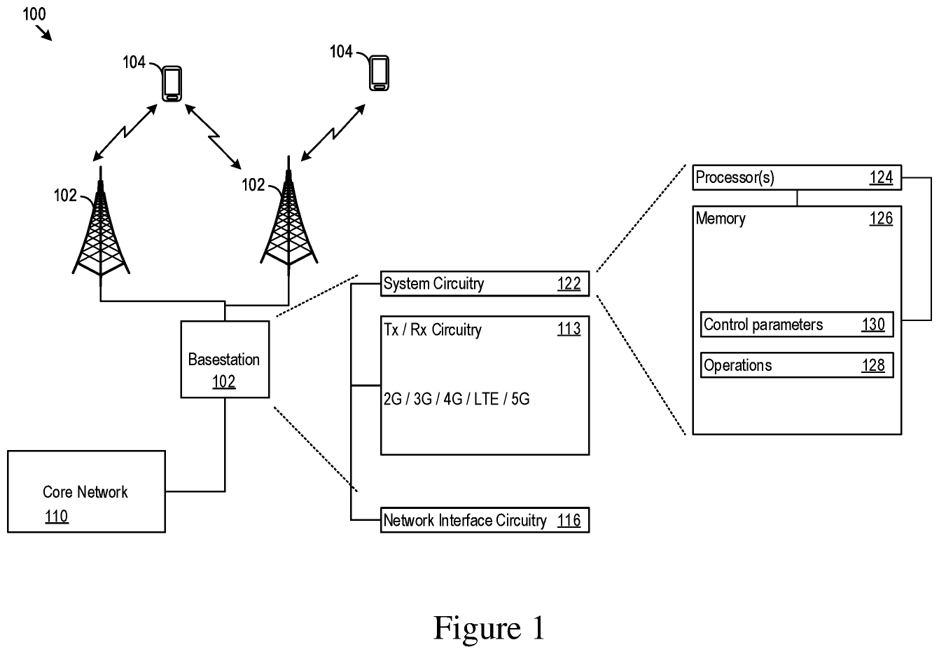

FIG. 1 shows an example base station 102. The base station may also be referred to as a network device or wireless network node. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals. Also, particular signals can be characterized or defined as either an uplink (UL) signal, a downlink (DL) signal, or a sidelink (SL) signal. An uplink signal is a signal transmitted from a UE 104 to a base station 102. A downlink signal is a signal transmitted from a base station 102 to a UE 104. A sidelink signal is a signal transmitted from one UE 104 to another UE 104.

For at least some specifications, such as 5G New Radio (NR), data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of physical channel. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a base station 102 to a UE 104. In other embodiments, the control information includes uplink control information (UCI) that is transmitted in the uplink direction from a UE 104 to a base station 102, or sidelink control information (SCI) that is transmitted in the sidelink direction from one UE 104 to another UE 104.

In addition, in some embodiments, a UE 104 may be configured to support at least one simultaneous UL transmission mode across a band pair for UL transmissions. In a first simultaneous UL transmission mode (also called a switchedUL mode), the UE 104 does not support simultaneous UL transmission across a band pair. Accordingly, when the UE 104 transmits an UL transmission in the first simultaneous UL transmission mode, the UE 104 transmits the UL transmission without simultaneously transmitting across a band pair. In addition, in a second simultaneous UL transmission mode (also called a dualUL mode), the UE 104 supports simultaneous UL transmission across a band pair. Accordingly, when the UE 104 transmits an UL transmission in the second simultaneous UL transmission mode, the UE 104 may transmit the UL transmission by simultaneously transmitting across a band pair.

Also, in some embodiments, the UE 104 may report the simultaneous UL transmission mode(s) to the base station 102. That is, the UE 104 may report, to the base station 102, that it supports simultaneous UL transmission across a band pair, that it does not support simultaneous UL transmission across a band pair, or that it both supports and does not support simultaneous UL transmission across a band pair. In particular of these embodiments, the UE 104 may report whether or not it supports simultaneous UL transmission across a band pair per band combination (BC). Also, the base station 102 may configured the simultaneous UL transmission mode (e.g., switchedUL or dualUL) per cell group, which may be considered as per BC or per band pair in embodiments where a 2Tx user device supports only two bands. That is, one available band pair in a band combination may support one simultaneous UL transmission mode.

Additionally, in general as used herein, a band combination may include a plurality of bands (e.g., five bands). In addition, as used herein, a band group may include up to three or four bands. A given band group may be included in or part of a band combination. Also, a band combination and/or a band group may include at least one band pair, where a band pair includes two bands.

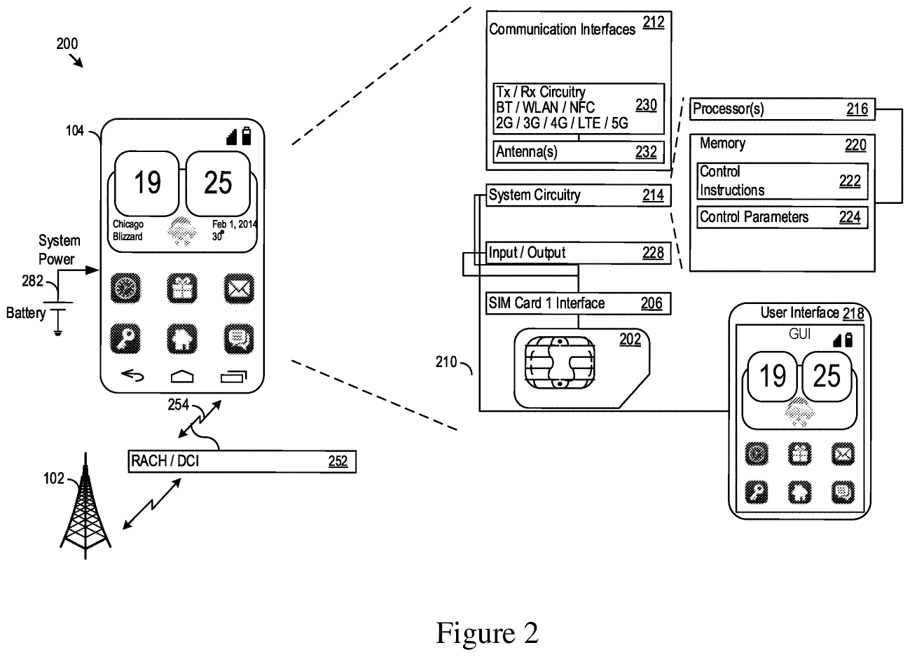

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC.

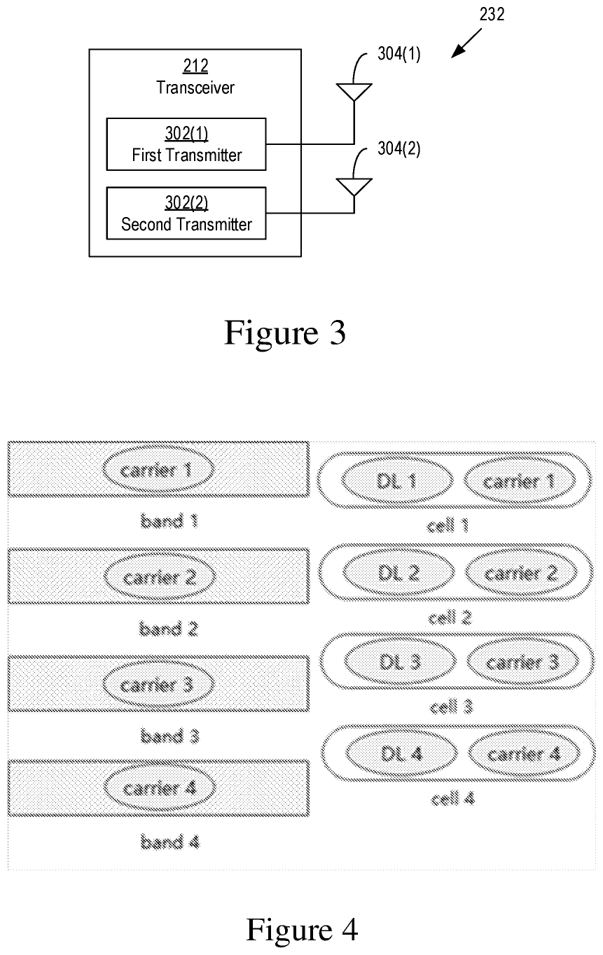

FIG. 3 shows a block diagram of an example configuration of the transceiver 212 and the antenna 232. In particular, the transceiver 212 includes a first transmitter (Tx) (or transmitter circuit) 302(1) and a second transmitter (Tx) (or transmitter circuit) 302(2). In addition, the antenna 232 may include a first antenna component 304(1) and a second antenna component 304(2). In general, the first transmitter 302(1) and the first antenna component 304(1) may form a first transmitter channel or chain, and the second transmitter 302(2) and the second antenna component 304(2) may form a second transmitter channel or chain. A UE 104, with the configuration in FIG. 2, may be configured to transmit a first UL transmission (or a first part of an UL transmission) using the first transmitter channel, and may be configured to transmit a second UL transmission (or a second part of a UL transmission) using the first transmitter channel.

In some embodiments, the UE 104 may use the two transmitter channels to transmit on one or two bands or carriers. The UE 104 may do so in any of various ways. For example, the UE 104 may transmit on a single carrier using both the first transmit channel and the second transmit channel. As another example, the UE 104 may transmit on a first carrier using the first transmit channel and on a second carrier using the second transmit channel. As used herein, the terms “1 Tx” and “1T” refer to use of one channel to transmit on one carrier, and the terms “2 Tx” and “2T” refer to the use of two transmit channels to transmit on one carrier. In addition, as used herein, the phrase “UL transmit case” refers to a particular configuration of the transmit channels used for an UL transmission on one or more carriers. Also, as described in further detail below, the UE 104 may switch between UL transmit cases during an UL Tx switching operation.

In addition, in various embodiments, the UE 104 may perform UL transmitter (Tx) switching to perform UL transmissions. In general, the UE 104 may perform UL Tx switching by switching from one UL transmit case to another UL transmit case. In operation, the UE 104 may transmit an UL transmission according to a first UL transmit case, and then may switch from the first UL transmit case to a second UL transmit case, and transmit an UL transmission according to the second UL transmit case. In addition, in various embodiments, UL transmit cases may also identify numbers of antenna ports corresponding to the carriers. The identification may be in the form of a mapping between carriers and respective numbers of antenna ports. For at least some of these embodiments, the numbers of antennas may depend on whether or not the UE 104 supports simultaneous transmission across a band pair.

FIG. 4 shows a block diagram illustrating relationships between carriers, bands, and cells. Two bands can be configured for UE to do TX switching. The new radio (NR) structure may be designed to operate in the operating bands defined for FR1 and FR2. For example, several bands in FR1 are shown in Table 1 below with a corresponding frequency region and duplex mode.

TABLE 1
Operating Bands.

| | Uplink (UL) | Downlink (DL) | |
|---|---|---|---|
| | operating band | operating band | |
| NR | BS receive/ | BS transmit/ | |
| operating | UE transmit | UE receive | Duplex |
| band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n41 | 2496 MHz-2690 MHz | 2496 MHz-2690 MHz | TDD |
| n76 | N/A | 1427 MHz-1432 MHz | SDL |
| n82 | 832 MHz-862 MHz | N/A | SUL |
| n91 | 832 MHz-862 MHz | 1427 MHz-1432 MHz | FDD |

For sub-band full duplex (SBFD), the uplink (UL) sub-band can be supported or configured within the downlink slots/symbols in a TDD carrier. Based on the Rel-16 variable duplex, n91 may be generated by combination SUL n82 with SDL n76. As described herein, there may be a soft or flexible band which is a combination of one or more bands with same or different kinds of duplex mode. The combination embodiments may be utilized even in single band operation.

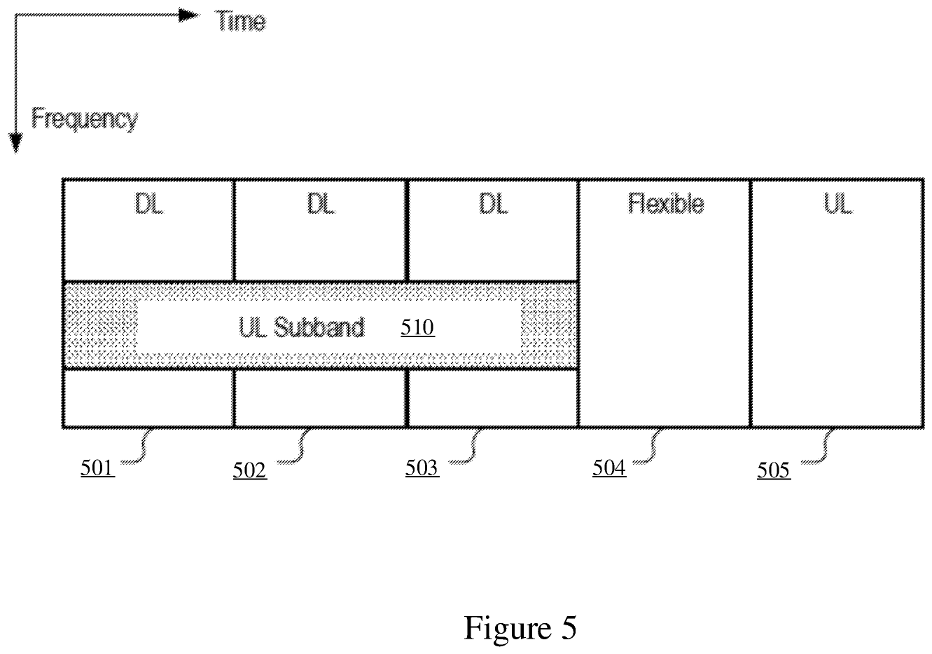

FIG. 5 illustrates a symbol/slot structure. The example shown is a DDDSU (501, 502, 503, 504, and 505). In this example, D represents a DL symbol/slot, U represents a UL symbol/slot, and S represents a flexible symbol/slot, which contains DL symbols and UL symbols. As shown, UL slots are fewer and discontinuous, and the characteristics affect the performance of UL transmission. In some embodiments, a full-duplex technology based on the UL sub-band may be implemented as sub-band full duplex (SBFD). FIG. 5 shows one type of the configuration pattern of the UL sub-band, wherein a UL sub-band 510 is configured in DL symbols/slots. In some embodiments, the UL sub-bands may be configured in some or all DL symbols/slots. The embodiments described below illustrate utilizing UE capabilities, including sharing of capabilities with complementation TDD.

For LTE or NR UE, the RF-to-baseband cost ratio may be 40:60 or 50:50. When the UE with a capability to support at least one capability to be used for at least two bands, the capability can be shared between two bands or among multiple bands and may include at least one of UE baseband processing capabilities (HARQ processes, PDCCH monitoring, BW size, enabling FDMed PDSCHs/PUSCHs in one carrier, bandwidth, number of BWP, number of physical channel, etc.), or any RF components (receiver, antenna, transmitter, PA, duplexer, etc). For a per carrier or per band capability, the capability may not be shared between two bands or among multiple bands. When band combination A+B is supported and reported by a UE, if only one cell on one band A is configured for the UE, or two cells are configured on band A+B for the UE while one of cells is deactivated, or two complementary TDD cells on band A+B are configured for the UE, the only one cell or two complementary TDD cells may be restricted by the single carrier/band capability. The capability on the other carrier/band may be not used. As a result, when a UE with a capability to support at least one capability to be shared/used for the two or multiple carriers/bands (e.g. bandwidth, number of BWP, number of physical channels, monitoring capability, HARQ processing number, MIMO layer, etc.). Capabilities between carriers can be shared for complementary TDD.

Complementary TDD Cells with Different Slot Directions

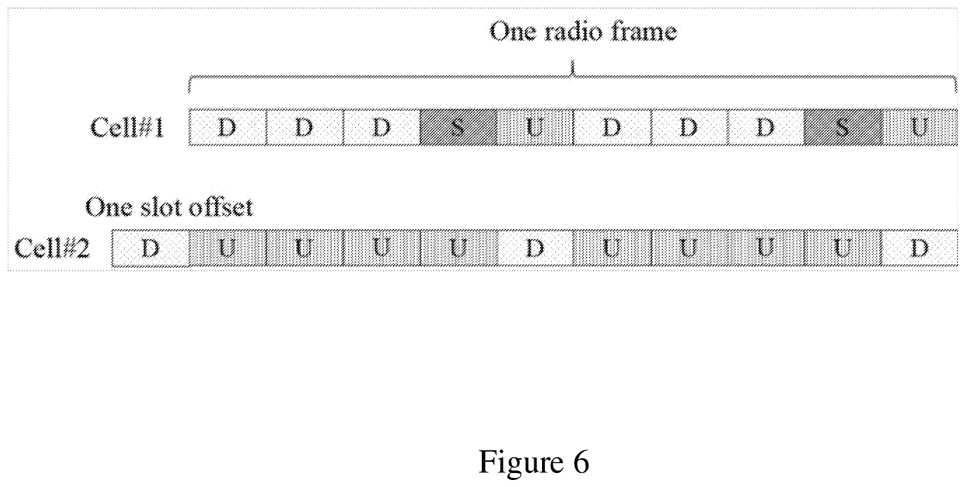

FIG. 6 illustrates complementary Time Division Duplex (TDD) Carrier Aggregation (CA). In one embodiment, there may be complementary two TDD cells, that are within a radio frame, the slot direction of each slot of the two TDD cells may be different. As shown in FIG. 6, Cell #1 is configured with frame structure of ‘DDDSU DDDSU’, Cell #2 is configured with frame structure of ‘DUUUU DUUUU’ and one slot offset. Cell #1 and Cell #2 are complementary TDD CA. Within this example embodiment, at least one capability sharing between the two cells can be supported. For example, the number of physical channels can be shared between the two cells, as a result, FDMed PDSCH can be supported in Cell #1 in the first slot of the frame, while FDMed PUSCH can be supported in Cell #2 in the first slot of the frame. In this embodiment, there may be an interaction of RRC configuration and UE capability report.

Since RRC configuration by the base station is after the UE capability report, there may be 1) one capability sharing between two cells or among multiple cells; or 2) one capability with enhanced value or enhanced function, which is available after a configuration of one type of CA or a configuration of one cell if UE had already reported to support the capability sharing or the capability with the enhanced value/function. Configuration of one type of CA may be for complementary TDD in one embodiment, but may include other example embodiments. This may include a configuration of one type of CA or a configuration of one cell, of which complementary TDD is one example. As described, there may be a UE capability report, RRC configuration by the base station, followed by the enhanced capability sharing described herein.

One type of CA could be complementary TDD CA, including all or partial complementary TDD CA. This may be from 2 or more cells/carriers. The configuration or definition of complementary TDD CA are described in these embodiments. For example, complementary TDD CA may include non-overlapped UL slot/symbol and/or DL slot/symbol between two cells or among cells. For example, partial complementary TDD CA may be non-overlapped UL slot or symbol between two cells or among cells. For example, partial complementary TDD CA may be non-overlapped DL slot or symbol between two cells or among cells. In another example, partial complementary TDD CA may be derived by a pattern configured by RRC signaling. In the following example embodiments, regardless of being partial or all complementary, the following embodiments are described using complementary.

A configuration of one cell could be explicitly RRC signaling which indicates at least one capability with enhanced value/function can be applied or at least one capability sharing between two cells or among multiple cells can be applied. For example, the capability with enhanced value/function can be derived by sharing the capability of at least one of other cells.

In some embodiments, a UE reports that it supports capability sharing for at least one capability. Taking two cells (Cell #1 and Cell #2) as an example, the capability on cell #1 is X, and the capability on cell #2 is Y, then the shared capability for cell #1 could be no less than X, no more than X+Y; and the shared capability for cell #2 could be no less than Y, and no more than X+Y. For example, a capability to process the number of PUSCH on cell #1 is one PUSCH per slot, a capability to process the number of PUSCH on cell #2 is one PUSCH per slot, as shown in FIG. 6. In a slot with different transmission direction, two PUSCH with FDMed is supported within UL slot on one cell if the shared capability supported.

The capability may include one or more enhanced values/functions. More than one value/function can be reported. In some embodiments, a UE reports that it supports the capability with one or more enhanced value/function for at least one capability. Taking two cells (Cell #1 and Cell #2) as an example, the capability on cell #1 is X or X1, and the capability on cell #2 is Y or Y1, which can be reported by the UE as a parameter per FS or FSPC. In this example, the X is basic value for the capability on cell #1, X1 is an enhanced capability for cell #1 which could be no less than X, no more than X+Y. The Y is basic value for the capability on cell #2, Y1 is an enhanced capability for cell #2 which could be no less than Y, and no more than X+Y. If the UE report two or more values/functions for one capability, it may signify that the shared capability is supported by the UE. The base station may further configure a parameter corresponding to at least one of the one or more enhanced value/function of the capability for at least one of the two cells. For example, a capability to process the number of PUSCH on cell #1 is X=one PUSCH per slot, X1=two PUSCH FDMed per slot, and a capability to process the number of PUSCH on cell #2 is Y=one PUSCH per slot, Y1=two PUSCH FDMed per slot, as shown in FIG. 6. This may be in a slot with a different transmission direction, or with a configuration to support the enhanced capability or capability sharing. It may further be based on an additional RRC configuration corresponding to the X1 and/or Y1 value of the capability, where two PUSCH with FDMed is supported on cell #1 and/or cell #2 within UL slot if the shared capability supported.

The timeline of the capability sharing available may be applied by one of: 1) an implicitly derived by RRC configuration, where there is no need to explicitly define the available time, just after the a configuration of one type of CA or a configuration of one cell (e.g. RRC configuration of complementary TDD CA); or 2) an explicitly derived by signaling (e.g. RRC, MAC CE, DCI) to configure or indicate the available time. This may be with an offset for available time. For example, a MAC CE may be used to activate/deactivate the sharing function, with or without a time offset. The time offset could be one or more symbols or slots and start at the end of the MAC CE or the DCI used to schedule the MAC CE.

In the embodiment, when TDD CA is supported by a UE, at least one capability can be shared and used between the two cells if complementary TDD CA is configured. The UE capability will not be wasted if two cells are complementary even when both the two cells are working simultaneously or within the same period/duration.

—Implicitly Defining Complementary TDD Cells with Different Slot Directions—

In one embodiment, there may be complementary TDD for two cells, that are within a radio frame, and the slot direction of each slot of the two TDD cells are different. In this embodiment, there is an implicit determination including configuration of complementary TDD CA.

For the example of TDD CA with two TDD cells, complementary TDD CA can be determined implicitly. The determination may be by at least one of TDD frame structure and unaligned frame boundary. For the two cells configured as TDD CA, the TDD frame structure (TDD-UL-DL-ConfigCommon, TDD-UL-DL-ConfigDedicated) is checked. In addition, there may be checks with unaligned frame boundary (ca-SlotOffset), or with slot format indication (SFI) by the UE.

The complementary TDD CA may be determined/defined by at least one of following conditions described below.

The first condition may be whether there is no overlapped slot with same direction between the cells or among cells. In some embodiments, F (Flexible) or S (special) slot can be regarded as different direction with both D slot and U slot. In some embodiments, F (Flexible) or S (special) slot can be regarded as different direction only with U slot. In some embodiments, F (Flexible) or S (special) slot can be regarded as different direction only with D slot. As shown in FIG. 6, based on the frame structure and unaligned frame boundary, the S slot may be regarded as different direction with both D slot and U slot and Cell #1 and Cell #2 are determined as complementary TDD CA.

In some embodiments, at least one of the following options may be applied in a slot with at least one cell configuring with S slot or F slot:
Option 1: do not apply capability sharing or the capability with enhanced value/function;
Option 2: apply capability sharing or the capability with enhanced value/function;
Option 3: only apply capability sharing or the capability with enhanced value/function on the cell without configuring with S slot or F slot;
Option 4: only apply capability sharing or the capability with enhanced value/function on the cell with configuring with S slot or F slot; or
Option 5: other than options 2-4, apply capability sharing or the capability with enhanced value/function with a scaling factor (e.g. the scaling factor is a value among 0 to 1, such as 0, 0.1, 0.2, 0.5, 1, etc.).

The second condition may be whether there are no overlapped symbols with the same direction between the cells or among cells. Any symbol within a frame will be checked, including the symbols in the S slot or F slot. In some embodiments, only the symbol within a frame except the symbol in S slot or F slot will be checked. When there is a slot with a D/U slot of one cell overlapped with the S slot of the other cell, the options described above may be applied. The symbols between two cells may be different.

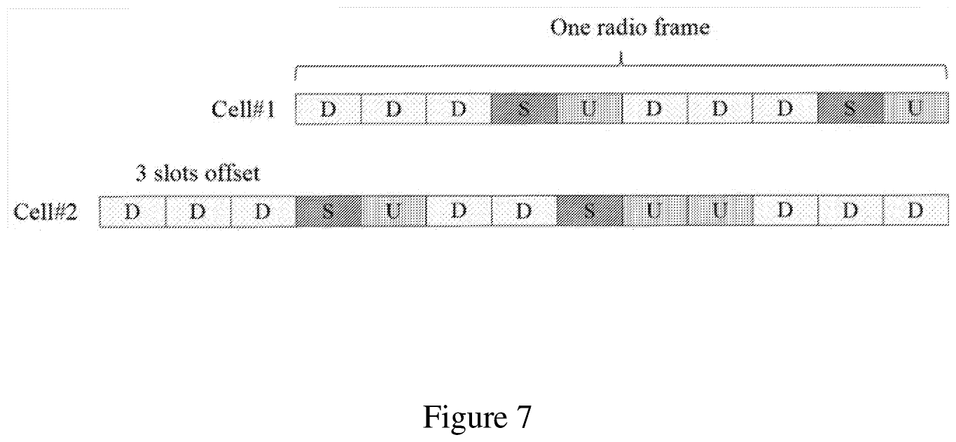

FIG. 7 illustrates uplink (UL) complementary Time Division Duplex (TDD) Carrier Aggregation (CA) without UL overlap and with three slots offset. The third condition may be whether there is no overlapped UL slot between the cells or among cells. As shown in FIG. 7, Cell #1 is configured with frame structure of ‘DDDSU DDDSU’, Cell #2 is configured with frame structure of ‘DDDSU DDSUU’ and a 3 slot offset. Cell #1 and Cell #2 are complementary TDD CA, or can be regarded as UL complementary TDD CA, based on a slot level. Only UL slot are not overlapped in the time domain between the two cells. Since there are no overlapped UL slots, one or more UL capability sharing or UL capability with enhanced value/function can be applied between the two cells. In some embodiments, with a slot with a D/U slot of one cell overlapped with S slot of the other cell, the options described above may be applied.

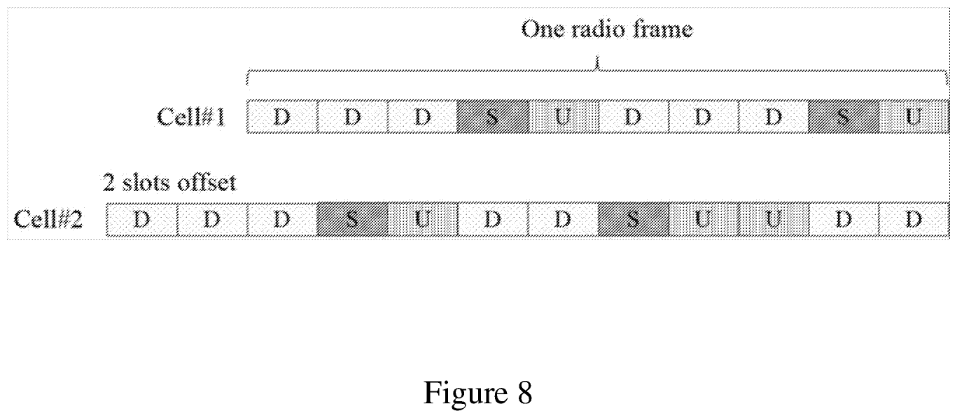

FIG. 8 illustrates uplink (UL) complementary Time Division Duplex (TDD) Carrier Aggregation (CA) without UL overlap and with two slots offset. For each slot, the UL symbol is non-overlapping. The fourth condition may be whether there is no overlapped UL symbol between the cells or among cells. As shown in FIG. 8, Cell #1 is configured with frame structure of ‘DDDSU DDDSU’, Cell #2 is configured with frame structure of ‘DDDSU DDSUU’ and a 2 slot offset. Cell #1 and Cell #2 are complementary TDD CA, or can be regarded as UL complementary TDD CA, based on a symbol level. Since there are no overlapped UL symbol, one or more UL capability sharing or UL capability with enhanced value/function can be applied between the two cells. In some embodiments, a slot with a D/U slot of one cell overlapped with S slot of the other cell, the options described above may be applied.

In some embodiments, similar as condition 3 or condition 4, the DL capability sharing can be applied if there are no overlapped DL slot/symbol between the cells or among cells.

The fifth condition may be whether there are at least one overlapped slot or symbol with different transmission direction between the cells or among cells. In some embodiments, when a slot with D/U slot of one cell is overlapped with S slot of the other cell, or in a slot or symbol with same transmission direction, the options described above may be applied.

In these embodiments, when TDD CA is supported by a UE, at least one capability can be shared and used between the two cells if complementary TDD CA is configured and implicitly determined by the UE without additional configuration. The UE capability may not be wasted if two cells are complementary even when both the two cells are working simultaneously or within the same period/duration.

—Explicitly Defining Complementary TDD Cells with Different Slot Directions—

In one embodiment, there may be complementary TDD for two cells, that are within a radio frame, and the slot direction of each slot of the two TDD cells are different. In this embodiment, there is an explicit determination including configuration of capability sharing or capability with enhanced value/function in complementary TDD CA.

For the embodiment with TDD CA with two TDD cells or with complementary TDD CA, the application of capability sharing or capability with enhanced value/function can be explicitly determined using an independent RRC parameter for configuration. In this embodiment, the TDD CA may be complementary, or more generally may be for configuration of whether the capability sharing or the capability with enhanced value/function can be applied.

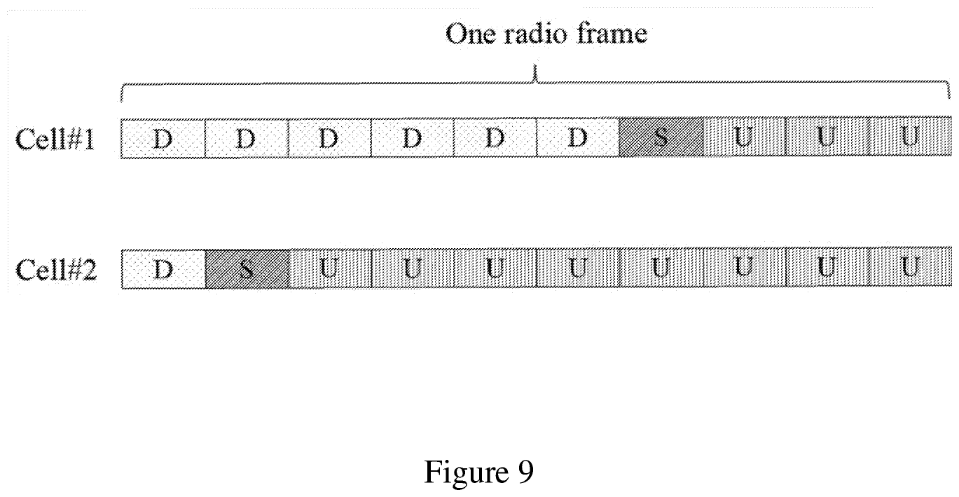

FIG. 9 illustrates Time Division Duplex (TDD) cells where partial slots are complementary. In some embodiments, the configuration or indication of capability sharing pattern may be applied for the capability with enhanced value/function. It may be based on RRC, MAC CE, or DCI. The pattern may include a slot pattern. For two TDD cells, as shown in FIG. 9, only partial slots are complementary, so a capability sharing slot pattern may be configured to permit the capability applied in the available slots. Within a frame and based on a reference cell (e.g. Cell #1), there may be a bitmap to determine the available slots (e.g. 0011110000, the available slots is the bit with set as ‘1’). This partial complementary embodiment may also be applied for the other embodiments described above, which were for a full complementary.

In alternative embodiments, when there are two TDD cells with different SCS, all the slots direction in the other cell within the same duration of the slot in the reference cell may be different with the slot direction in the reference cell, so the slot is available to apply the shared capability or the capability with enhanced value/function. In some embodiments, not all the slots' directions in the other cell within the same duration of the slot in the reference cell are different with the slot direction in the reference cell. The slots with different direction may be available to apply the shared capability or the capability with enhanced value/function. Further, with a symbol level pattern, a bitmap for available symbols or available slot and symbol may be applied.

In this embodiment, when TDD CA is supported by a UE, at least one capability can be shared and used between the two cells if complementary TDD CA is configured and explicitly determined by additional configuration. The UE capability may not be wasted if two cells are complementary even when both the two cells are working simultaneously or within the same period/duration.

—Implicitly Determining Partial Complementary TDD for More than Two Cells with Different Slot Direction—

In one embodiment, there may be complementary TDD for more than two cells, that are within a radio frame, and the slot direction of the slots of the TDD cells are different. In this embodiment, there is an implicit determination including configuration of capability sharing or capability with enhanced value/function in complementary TDD CA.

For TDD CA with two or more TDD cells and complementary TDD CA, the application of capability sharing or capability with enhanced value/function may be determined in a few different ways. First, the determination may be made using an independent RRC parameter to configure. For example, it may determine whether the TDD CA is complementary, or more generally to configure whether the capability sharing or the capability with enhanced value/function can be applied.

Second, the determination may be made to configure/indicate capability sharing pattern or a pattern to apply the capability with enhanced value/function. This may be based on RRC, MAC CE, or DCI. The pattern may include a carrier/cell pattern that may be configured and used for capability sharing.

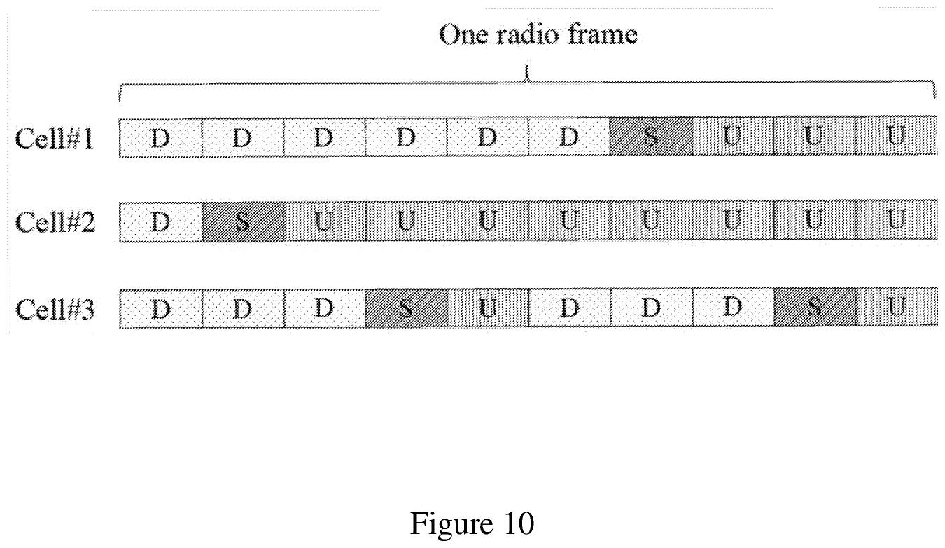

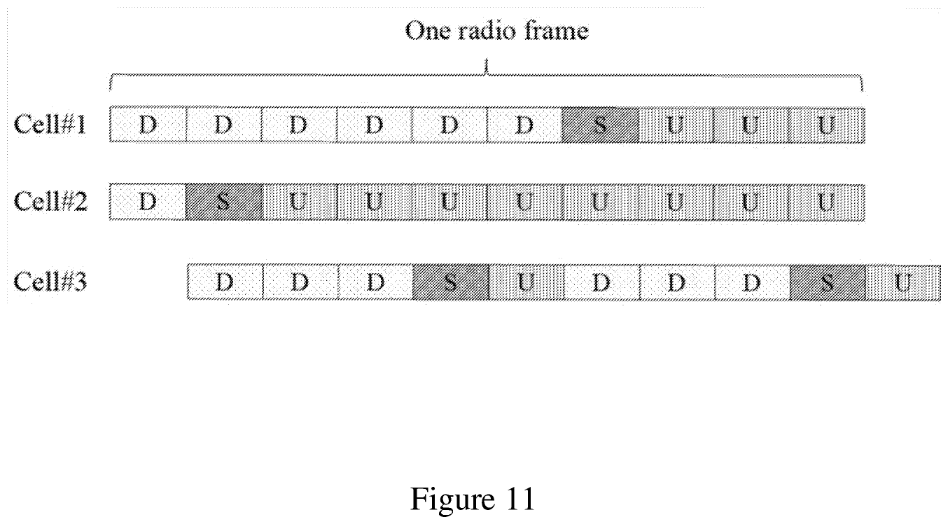

FIG. 10 illustrates an embodiment of Carrier Aggregation (CA) with three Time Division Duplex (TDD) cells. FIG. 11 illustrates Carrier Aggregation (CA) with three Time Division Duplex (TDD) cells in which one cell is configured with slot offset. For three TDD cells, as shown in FIG. 11, Cell #1 and Cell #3 may be the paired cells to apply at least one UL capability sharing. The cell pattern (cell #1, cell #3) may be used for the TDD CA to apply UL capability sharing.

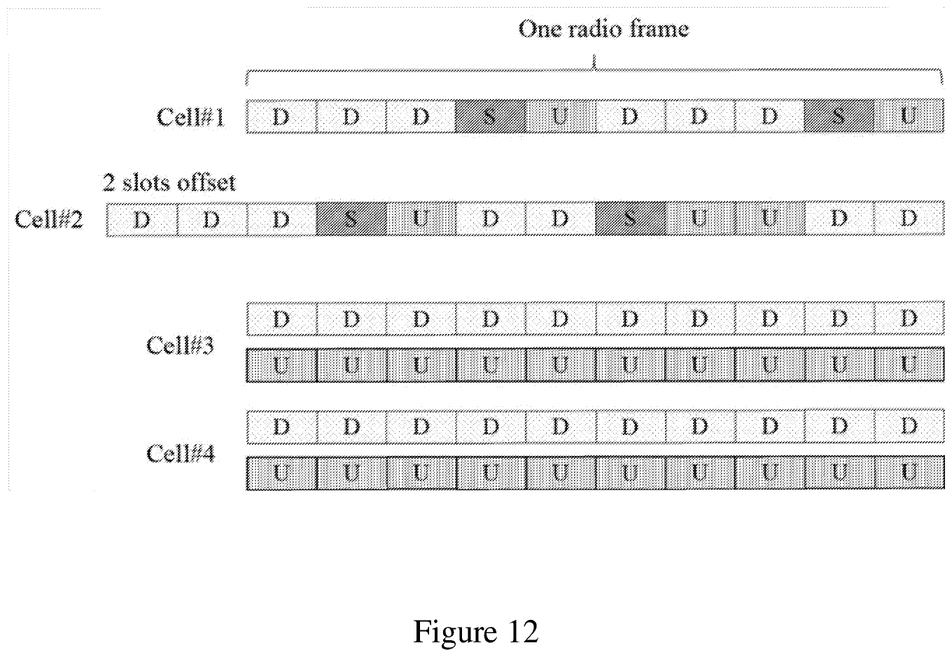

FIG. 12 illustrates an embodiment of Carrier Aggregation (CA) with four cells in which one cell is configured with slot offset. In another example of TDD-FDD CA in FIG. 12, the cell pattern is (cell #1, cell #2).

In an alternative embodiment, there may be a different slot and carrier/cell pattern. For example, there may be an independent pattern. For three TDD cells, as shown in FIG. 11, cell #1 and Cell #2 can be the paired cells to apply at least one UL capability sharing on partial slots. The cell pattern is (cell #1, cell #2), the slot pattern is 0011110000. In another example, there may be a joint pattern, where for three TDD cells, as shown in FIG. 11, (cell #1, cell #2) or (cell #2, cell #3) can be the paired cells to apply to at least one UL capability sharing on partial slots. The joint slot-cell pattern is ‘B,0,A,A,A,A,B,B,B,0’, where ‘0’ means no sharing, ‘A’ means (cell #1, cell #2), ‘B’ means (cell #2, cell #3). In another example, the joint slot-cell pattern may be ‘B,0,A,A,A,C,B,B,C,0’, wherein ‘0’ means no sharing, ‘A’ means (cell #1, cell #2), ‘B’ means (cell #2, cell #3), ‘C’ means (cell #1, cell #3).

In alternative embodiments, when two or multiple cells with different SCS, all the slots direction in the other cell within the same duration of the slot in the reference cell may be different with the slot direction in the reference cell, so the slot is available to apply the shared capability or the capability with enhanced value/function. In some embodiments, not all the slots' directions in the other cell within the same duration of the slot in the reference cell are different with the slot direction in the reference cell. The slots with different direction may be available to apply the shared capability or the capability with enhanced value/function. With a symbol level pattern, a bitmap for available symbols or available slot and symbol can be applied.

In some embodiments, where there is different bandwidth, ‘one cell to multiple cells sharing’ or ‘multiple cells to one cell sharing’ may be applied. For example, as shown in FIG. 11, assume BW of cell #1+ cell #2=BW of cell #3, (cell #1& #2, cell #3) pattern can be applied in slot #0,7,8. For example, as shown in FIG. 12, assume BW of cell #3+ cell #4=BW of cell #1 or cell #2, (cell #1, cell #3& #4) or (cell #2, cell #3& #4) pattern can be applied in slot #0 for at least one UL capability sharing.

In alternative embodiments, the capability with one or more enhanced value/function per cell/carrier/band will be reported by the UE. A different value may correspond to what is shared from different one of more other cells. For example, the capability on cell #1 is X or X1 or X2 or X3, and the capability on cell #2 is Y or Y1 or Y2 or Y3, and the capability on cell #3 is Z or Z1 or Z2 or Z3, which can be reported by the UE as a parameter per FS or FSPC, where the X is a basic value for the capability on cell #1, X1 is an enhanced capability for cell #1 which could be no less than X, no more than X+Y; X2 is an enhanced capability for cell #1 which could be no less than X, no more than X+Z, X3 is an enhanced capability for cell #1 which could be no less than X, no more than X+Y+Z; where the Y is a basic value for the capability on cell #2, Y1 is an enhanced capability for cell #2 which could be no less than Y, no more than X+Y, Y2 is an enhanced capability for cell #2 which could be no less than Y, no more than Z+Y, Y3 is an enhanced capability for cell #2 which could be no less than Y, no more than X+Z+Y; where the Z is a basic value for the capability on cell #3, Z1 is an enhanced capability for cell #3 which could be no less than Z, no more than X+Z, Z2 is an enhanced capability for cell #3 which could be no less than Z, no more than Z+Y; Z3 is an enhanced capability for cell #3 which could be no less than Z, no more than Z+Y+X. For the pattern (cell #1& #2, cell #3) to be applied in slot #0,7,8, the capability with Z3 will be referred as cell #3, and/or the capability with X2 will be referred of cell #1, and Y2 will be referred of cell #2.

In alternative embodiments, if capability sharing is supported, the shared capability for each cell will be determined by implicitly or explicitly scaling between or among cells. For example, a pattern (cell #1& #2, cell #3) can be applied in slot #0,7,8, the capability sharing or the capability with enhanced value/function with a scaling factor may be referred of one cell (e.g. the scaling factor is a value among 0 to 1, such as 0, 0.1, 0.2, 0.5, 1, etc.). Or it may be a value among 0 to M, where M is a value no less than 1, e.g. 0, 0.1, 0.2, 0.5, 1, 1.5, 2, etc.

In an alternative embodiment, there may be an implicitly derived capability sharing pattern by frame structure (TDD-UL-DL-ConfigCommon, TDD-UL-DL-ConfigDedicated, ca-SlotOffset, SFI). Based on slot level pattern, only the same slot with different direction may be the available slots (e.g. slot pattern ‘0011110000’ is derived in FIG. 9). Based on the cell level pattern, only all the slots or symbols in a frame with a different direction may be the available paired cells. Alternatively, all the UL slots or symbols, or all the DL slot or symbols in a frame are not overlapped may be the available paired cells. For example, cell pattern (cell #1, cell #3) is derived in FIG. 11 and the cell pattern (cell #1, cell #2) is derived in FIG. 12.

In this embodiment, when TDD CA is supported by a UE, at least one capability can be shared and used between the two cells if complementary TDD CA is configured and explicitly determined by additional configuration. The UE capability may not be wasted if two cells are complementary even when both the two cells are working simultaneously or within the same period/duration.

—Determining Complementary TDD for More than Two Cells with Different Slot Directions—

In one embodiment, there may be complementary TDD for more than two cells, that are within a radio frame, and the slot direction of the slots of the TDD cells are different. In this embodiment, there is a determination including configuration of capability sharing or capability with enhanced value/function in complementary TDD CA.

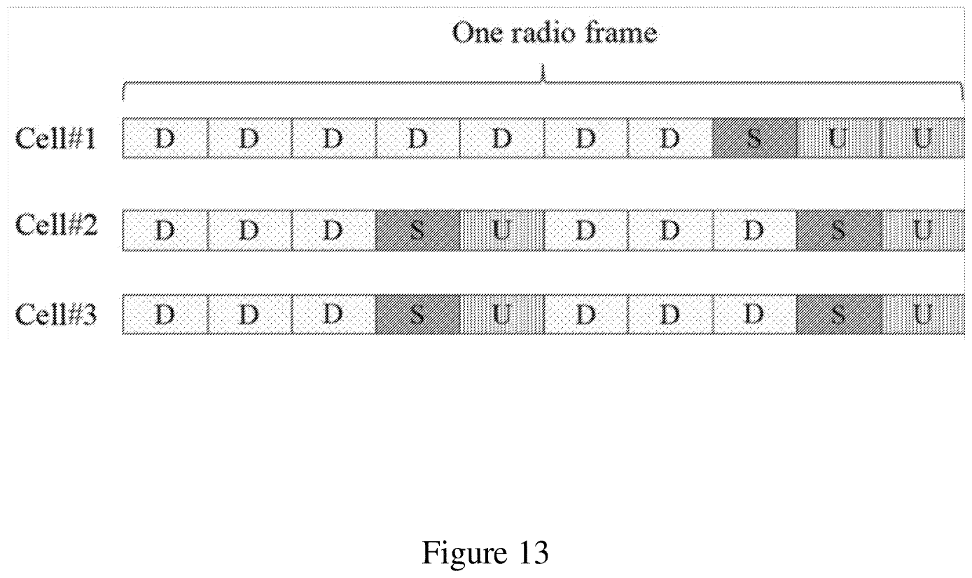

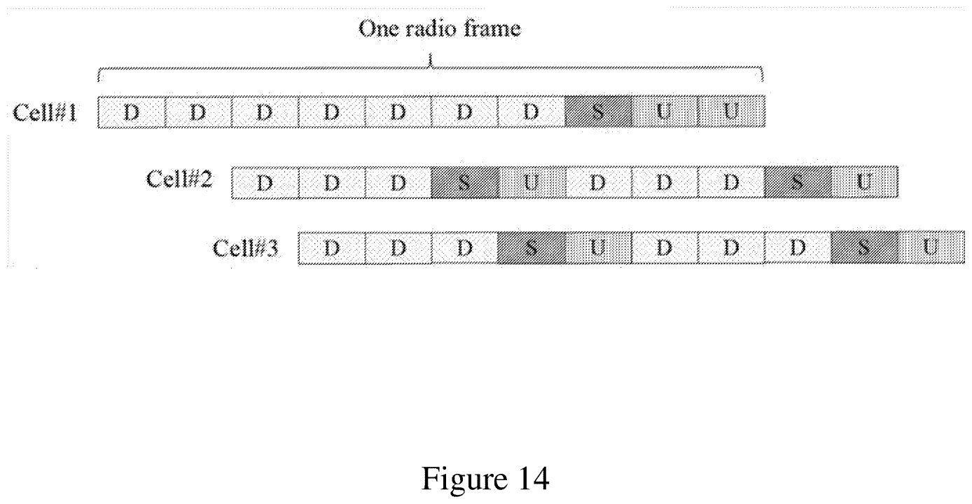

For TDD CA with two or more TDD cells and complementary TDD CA, the application of capability sharing or capability with enhanced value/function may be determined in a few different ways. FIG. 13 illustrates another embodiment of Carrier Aggregation (CA) with three Time Division Duplex (TDD) cells. FIG. 14 illustrates Carrier Aggregation (CA) with three Time Division Duplex (TDD) cells in which two cells are configured with slot offset.

First, there may be a report for the configuration of cells. The determination may be made to report/configure/indicate the number of the cells for capability sharing. As shown in FIG. 14, report/configure 2 or 3 cells can be applied the capability sharing. This may be combined with the embodiments described above to identify complementary. For example, there may be an implicit determination by at least one of TDD frame structure and unaligned frame boundary. For the two or more cells configured as TDD CA, the TDD frame structure (TDD-UL-DL-ConfigCommon, TDD-UL-DL-ConfigDedicated) may be checked, with unaligned frame boundary (ca-SlotOffset), or with SFI (slot format indication) by the UE. The complementary TDD CA may determined/defined by at least one of the conditions 3, 4, 5 described above. There may be no UL symbol/slot overlapped in TDD CA with more than two cells, as shown in FIG. 14. This may also apply to DL symbol/slot.

Second, there may be a configuration for capability sharing cell/carrier pair/combination. As shown in FIG. 14, a report/configure cell pair/combination may be applied for the capability sharing (e.g. {cell #1, cell #3}). There may be a report of multiple cell pairs/combinations to determine/configure one pair/combination (e.g. report {(cell #1, cell #2), (cell #1, cell #3), (cell #1, cell #2, cell #3)} and configure {cell #1, cell #3}). This may be combined with the embodiments above that identify complementary.

In some embodiments, there may be a configuration of capability sharing pattern. More than two cells combination may be used to apply the pattern. For example, set to ‘1’ in the slot pattern could be (cell #1, cell #2, cell #3). For example, (cell #1, cell #2, cell #3) can be one of candidate cell pattern. Three or more cells complement and capability sharing among three or more cells can be applied.

In this embodiment, when TDD CA is supported by a UE, at least one capability can be shared and used between the two cells if complementary TDD CA is configured and explicitly determined by additional configuration. The UE capability may not be wasted if two cells are complementary even when both the two cells are working simultaneously or within the same period/duration.

### —Sharing DL/UL Capability—

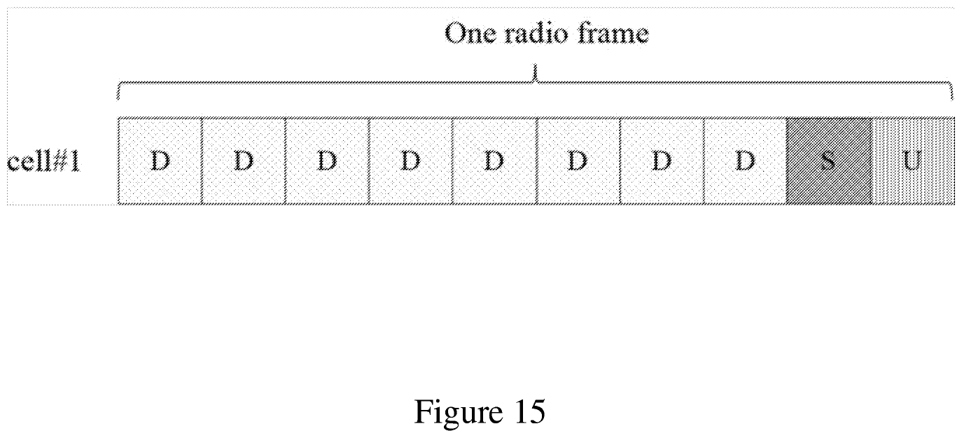

This embodiment is for TDD sharing for a single cell. Besides complementary TDD CA, for a single TDD cell, there may be other capabilities of DL and UL that can be shared. FIG. 15 illustrates a single Time Division Duplex (TDD) cell or carrier with an unbalanced downlink (DL) and uplink (UL) ratio. With single TDD cell, due to the unbalanced D/U ratio, as shown in FIG. 15, some UL capabilities may be shared and used for DL, or some DL capabilities may be shared and used for UL. For example, a UE capability includes “Processing one unicast DCI scheduling DL and one unicast DCI scheduling UL per slot per scheduled CC for FDD; Processing one unicast DCI scheduling DL and 2 unicast DCI scheduling UL per slot per scheduled CC for TDD.” In other words, 1 DL DCI and 1 UL DCI may be supported for FDD, while 1 DL DCI and 2 UL DCI may be supported for TDD, which can be regarded as “the capability of scheduling UL per slot can be shared/aggregated used in D slot from U slot.”

Some enhancement for capability sharing in single TDD cell may include a UE capability report to support at least one capability sharing between DL carrier and UL carrier in a single TDD cell, or a capability with enhanced value/function. In some embodiments, there may be a combination with a RRC configuration on at least one capability sharing supported between DL carrier and UL carrier, or the configuration corresponding to the capability with enhanced value/function. In some embodiments, a max value or threshold of a capability for the TDD cell, UL carrier and DL carrier may be the same. In some embodiments, a max value or threshold of a capability for the TDD cell and DL carrier may be the same. In some embodiments, a max value or threshold of a capability for the TDD cell and UL carrier may be the same. In some embodiments, the shared max value for the TDD cell is configurable (e.g. no less than each threshold of DL carrier and UL carrier).

As shown in FIG. 15, due to the unbalanced D/U ratio, some or all UL HARQ Process/buffer/entity may be shared and used for DL. For example, when UE reports DL and UL HARQ Process sharing or reports a higher value for DL and/or UL HARQ Process, 32 HARQ Process can be supported for a TDD cell, max of DL HARQ Process is 32, max of UL HARQ Process is 32, max DL+UL total HARQ Process is 32. In some embodiments, if 32 HARQ Process capability in FR2-2 is supported, the max value may be 64.

In some embodiments, DL and UL sharing may be applied for (TDD) CA, that is for more than one cell, and at least one capability for DL and UL can be shared. For example, DL search space sharing and UL search space sharing are two independent capabilities. When only DL search space sharing is reported, if DL and UL sharing is supported (reported/configured), UL grant may be supported for the DL shared search space.

In this embodiment with a single TDD cell or carrier, at least one capability can be shared and used within the cell between DL carrier and UL carrier. The UE capability may not be wasted due to the unbalanced D/U ratio.

### —Single Carrier Cell Configuration—

Other than complementary TDD CA, for a single TDD cell with sub-band full duplex (SBFD), there may be one or more capabilities of DL and UL that can be shared, or capabilities of the DL and UL sub-band can be shared. In this embodiment, a capability may be reported per cell, per DL carrier, or per UL carrier. In some embodiments, there may be a reporting per sub-band, per DL sub-band, or per UL sub-band.

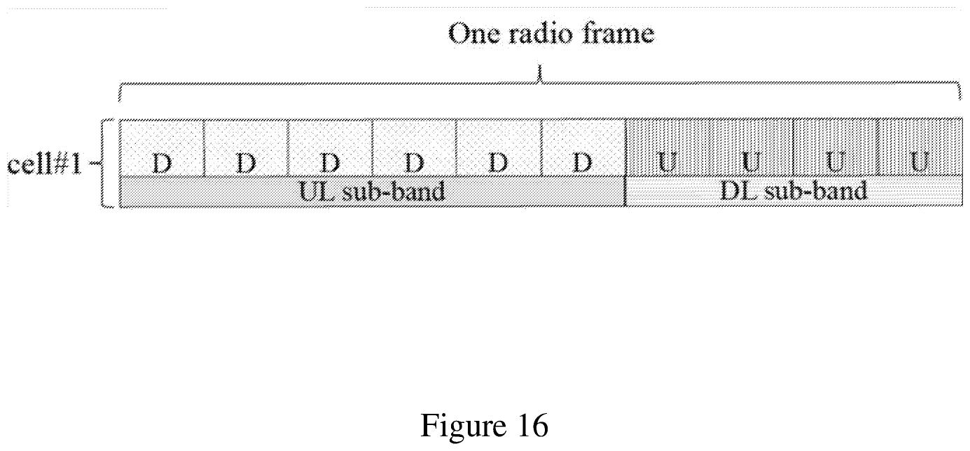

FIG. 16 illustrates a single Time Division Duplex (TDD) cell or carrier with a downlink (DL) sub-band and an uplink (UL) sub-band. If sub-band capability sharing or a capability with enhanced value/function is supported, a capability per cell/carrier can be shared and used between/among DL/UL sub-bands. As shown in FIG. 16, when UL sub-band is supported/configured in DL slot and/or when DL sub-band is supported/configured in UL slot, it may be similar as capability sharing for complementary TDD CA discussed in the other embodiments. For example, the embodiments for complementary TDD CA for single TDD carrier with SFBD may apply. The enhanced value/function, or the threshold of the shared capability may be determined by the capability of the cell or carrier. In FIG. 16, both UL and DL are configured in a single cell or may be similar to complementary TDD that involves two cells. Since capability of sub-band may be a subset of the capability of its original carrier, the shared capability between/among sub-bands may be similar as original carrier/cell capability, which can be extended to complementary TDD CA.

In this embodiment with a single TDD cell or carrier with SBFD, at least one capability can be shared and used within the cell between/among DL/UL sub-bands. The UE capability may not be wasted as with complementary TDD-CA.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software-based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
receiving a configuration for a type of carrier aggregation (CA) for multiple carriers, or a configuration for one carrier among the multiple carriers; and
utilizing a capability among the multiple carriers or for the one carrier based on the configuration.

2. The method of claim 1, wherein the type of CA for multiple carriers comprises a complementary Time Division Duplex (TDD).

3. The method of claim 1, wherein the utilizing the capability among the multiple carriers comprises sharing the capability between two cells or among cells, between a downlink (DL) carrier and an uplink (UL) carrier in one cell, or between two sub-bands or among multiple sub-bands.

4. The method of claim 2, wherein the complementary TDD is determined by at least one of frame structure and frame boundary offset.

5. The method of claim 4, wherein the complementary TDD is determined with one of following conditions: a) there is no overlapped slot with a same direction between two cells; b) there is no overlapped symbol with a same direction between two cells; c) there is no overlapped UL slot among cells; d) when there is no overlapped UL symbol among cells; e) there is no overlapped DL slot among cells; f) when there is no overlapped DL symbol among cells; or g) there is at least one overlapped slot or symbol with a different direction among cells.

6. The method of claim 2, wherein the complementary TDD is determined by an RRC parameter to configure.

7. The method of claim 1, further comprising:
utilizing the capability among the multiple carriers by a pattern.

8. The method of claim 7, wherein the pattern comprises a slot pattern, a carrier pattern, or a joint pattern.

9. The method of claim 8, wherein
for the slot pattern, the utilizing the capability among the multiple carriers or for the one carrier for the slot corresponds with one value in the slot pattern; or,
for the cell pattern, the utilizing the capability among the multiple carriers is based on an indication of the carrier pattern; or,
for the joint pattern, the utilizing the capability among the multiple carriers or for the one carrier for the slot corresponds with one value for a carrier combination in the slot pattern.

10. (canceled)

11. (canceled)

12. The method of claim 8, further comprising:
deriving the pattern by an RRC parameter, or by at least one of frame structure and frame boundary offset.

13. The method of claim 2, further comprising:
indicating a number of the carriers for application of the capability.

14. The method of claim 2, further comprising:
receiving one carrier combination for application of the capability based on reported multiple carrier combinations.

15. The method of claim 1, further comprising:
applying the capability based on an enhanced value among the multiple carriers or for the one carrier.

16. The method of claim 15, further comprising
reporting, by a user equipment (UE), support of the enhanced value of the capability; or
reporting, by the UE, support of the capability that can be shared among cells.

17. The method of claim 16, wherein the capability is available after the configuration, and after the UE had performed the reporting of the support of the enhanced value of the capability or reporting of the support of the capability can be shared among cells.

18. The method of claim 15, wherein the configuration comprises a parameter based on the enhanced value of the capability.

19. The method of claim 15, wherein the utilizing the capability among the multiple carriers or for the one carrier is based on the configuration that is further activated/deactivated by a Medium Access Control (MAC) Control Element (CE).

20. The method of claim 19, wherein the utilizing the capability among the multiple carriers or for the one carrier is based on the configuration that is further activated/deactivated by the MAC CE with a time offset.

21. A wireless communications apparatus comprising a processor and a memory, wherein the processor is configured to read code from the memory and implement a method comprising:
receiving a configuration for a type of carrier aggregation (CA) for multiple carriers, or a configuration for one carrier among the multiple carriers; and
utilizing a capability among the multiple carriers or for the one carrier based on the configuration.

22. A non-transitory computer program product comprising a computer-readable program medium code stored thereupon, the code, when executed by a processor, causing the processor to implement a method comprising:
receiving a configuration for a type of carrier aggregation (CA) for multiple carriers, or a configuration for one carrier among the multiple carriers; and
utilizing a capability among the multiple carriers or for the one carrier based on the configuration.
